(19) United States
(12) Patent Application Publication
(10) Pub. No.: US 2008/0178252 A1
(43) Pub. Date: Jul. 24, 2008

(54) Password Installation in Home Networks

(75) Inventor: Ted R. Michaud, Medford, NJ (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/624,362

(22) Filed: Jan. 18, 2007

(51) Int. Cl. G06F 19/00; H04L 9/32

(52) U.S. Cl. 726/1; 726/6

(57) ABSTRACT

An arrangement is provided for securely sharing data on a network by enabling a user to select and install a commonly-shared password in each terminal device that is on the network. The terminal devices are then able to form a network that is temporarily secured using the user-installed password. A terminal-generated password is next created by one of the terminal devices and distributed over the temporarily secured network to the other devices. The terminal-generated password replaces the user-generated password so that the network is reformed and secured using the terminal-generated password. In one illustrative example, the terminal-generated password is created using a unique identifier, such as one or more MAC (Media Access Control) addresses associated with terminal devices on the network, as an input to a hash function that generates the new password having sufficient length and randomness to provide robust protection against password attack.

### TECHNICAL FIELD

This invention is related generally to networking, and more particularly to the installation of passwords to maintain privacy in a home multimedia network.

### BACKGROUND

Many networks implement security by relying on a common password that is shared among networked devices. Communications are then arranged to be limited to only those network devices that possess the commonly-shared password. Network security is typically enhanced by requiring the use of a plurality of alpha-numeric characters in the password to avoid discovery of the password by simple trial and error.

Despite their wide usage, user-selected passwords can have shortcomings. Simple or meaningful passwords may be easier for users to remember when they are installed on several networked devices, but they are vulnerable to discovery, or hacking attacks by persons seeking unauthorized access to the network. Passwords that are complex and arbitrary are generally more secure, but can be difficult to remember. Since users can often only remember a limited number of passwords, they tend to rely upon simple passwords. Even in cases where a user wants to use a more secure password, the steps taken to do so can often prove to be cumbersome or difficult.

### DESCRIPTION OF THE DRAWINGS

FIG. 1 is a pictorial representation of an illustrative home network having a plurality of terminal devices that are coupled to several broadband multimedia sources;

FIG. 2 is a block diagram of an illustrative multimedia delivery network having a network headend, hubs coupled to the headend, and nodes coupled to the hubs, where the nodes each provide broadband multimedia services to a plurality of homes;

FIG. 3 is a pictorial representation of an illustrative multiple dwelling unit having a number of apartments, each with a plurality of terminal devices, where the apartments share common infrastructure to receive broadband multimedia services;

FIG. 4 is a block diagram of an illustrative wide area network and a local area network which share a common portion of physical infrastructure;

FIG. 5 is a functional block diagram of an illustrative local area network having a plurality of terminal devices that are also coupled to a wide area network;

FIG. 6 is a functional block diagram showing user-generated password installation into the terminal devices shown in FIG. 5 and creation and distribution of a terminal-generated password over a local area network;

FIG. 7 is a pictorial view of an illustrative graphical user interface screen displayed on a monitor coupled to a terminal device for enabling user input of a user-generated password and a text description for the terminal device;

FIG. 8 is a block diagram showing components forming an illustrative password installation application or application programming interface (“API”);

FIG. 9 is a pictorial view of an illustrative graphical user interface screen displayed on a monitor coupled to a terminal for enabling a user to verify a network configuration and complete a transition to a terminal-generated password;

FIG. 10 is a functional block diagram of an illustrative media server that is coupled to a wide area network and a local area network;

FIG. 11 shows an illustrative installation tool that hosts a password installation application or API;

FIG. 12 is a flowchart of an illustrative method for installing passwords in terminal devices on a local area network; and

FIG. 13 is a diagram showing an illustrative shared-key authentication message flow between terminal devices over a local area network.

### DETAILED DESCRIPTION

An arrangement is provided for securely sharing data on a network by enabling a user to select and install a commonly-shared password in each terminal device that is on the network. The terminal devices are then able to form a network that is temporarily secured using the user-installed password. A terminal-generated password is next created by one of the terminal devices and distributed over the temporarily secured network to the other devices. The terminal-generated password replaces the user-generated password so that the network is reformed and secured using the terminal-generated password. In one illustrative example, the terminal-generated password is created using a unique identifier, such as one or more MAC (Media Access Control) addresses associated with terminal devices on the network, as an input to a hash function that generates the new password having sufficient length and randomness to provide robust protection against password attack.

In other illustrative examples, a user interface is provided which enables a user to input text descriptions (for example “set top box in master bedroom”) that are associated with respective terminal devices on the network. After the installation of the common user-generated password is completed at each of the terminal devices, the user may view a display that shows all of the devices by MAC address and the associated descriptive text. Once the user confirms that all of the displayed terminal devices are desired to be part of the network (and there are no undesired terminal devices shown), the user may initiate creation and distribution of the terminal-generated password to the confirmed terminal devices.

Such a two-step password installation arrangement provides a number of advantages. Since the user-generated password is typically chosen to be short and easily remembered, the installation of the commonly-shared password in all the terminal devices that is required to form the network is made easier. And once the network is formed using the user-generated password, the robust terminal-generated password is quickly distributed over the network from a single point. Thus, the more limited security that results from use of the typically simple user-generated password is only temporary.

The principles of the present two-step password installation using both a user-generated and a terminal-generated password are next illustrated in the context of a home multimedia network. In this setting, media content streamed from a service such as cable- or satellite-television service is stored and accessed from a variety of devices that are connected to the home network. However, it is emphasized that the home multimedia network environment merely provides one illustrative context for the present arrangement. In addition, although the subject matter has been described in language specific to structural features and/or methodological acts in the home networking context, it is to be understood that the subject matter defined in the appended claims is not necessarily limited to the specific features or acts described above. Rather, the specific features and acts described are disclosed as example forms of implementing the claims.

Digital video recorders (“DVRs”) have become increasingly popular for the flexibility and capabilities offered to users in selecting and then recording video content such as that provided by cable- and satellite-television service companies. DVRs are consumer electronics devices that record or save television shows, movies, music, and pictures, for example, (collectively “multimedia”) to a hard disk in digital format. Since being introduced in the late 1990s, DVRs have steadily developed additional features and capabilities, such as the ability to record high definition television (“HDTV”) programming. DVRs are sometimes referred to as personal video recorders (“PVRs”).

DVRs allow the “time shifting” feature (traditionally enabled by a video cassette recorder or “VCR” where programming is recorded for later viewing) to be performed more conveniently, and also allow for special recording capabilities such as pausing live TV, fast forward and fast backward, instant replay of interesting scenes, and skipping advertising and commercials.

DVRs were first marketed as standalone consumer electronic devices. Currently, many satellite and cable service providers are incorporating DVR functionality directly into their set-top-boxes (“STBs”). As consumers become more aware of the flexibility and features offered by DVRs, they tend to consume more multimedia content. Thus, service providers often view DVR uptake by their customers as being desirable to support the sale of profitable services such as video on demand (“VOD”) and pay-per-view (“PPV”) programming.

Once consumers begin using a DVR, the features and functionalities it provides are generally desired throughout the home. To meet this desire, networked DVR functionality has been developed which entails enabling a DVR to be accessed from multiple rooms in a home over a network. Such home networks often employ a single, large capacity DVR that is placed near the main television in the home. A series of smaller companion terminals, which are connected to other televisions, access the networked DVR over the typically existing coaxial cable in the home. These companion terminals enable users to see the DVR output, and to use the full range of DVR controls (pause, rewind and fast-forward among them) on the remotely located televisions. In some instances, it is possible for example, to watch one recorded DVR movie in the office while somebody else is watching a different DVR movie in the family room.

The home network must be secured so that the content stream from the DVR is not unintendedly viewed should it leak back through the commonly shared outside coaxial cable plant to a neighboring home or adjacent subscriber in a multiple dwelling unit (“MDU”) such as an apartment building. In some implementations of home networking, a low pass filter is installed at the entry point of the cable to the home to provide radio frequency (“RF”) isolation. In other implementations, a password is installed at each terminal in the home network that enables the media content from the DVR to be securely shared. Terminals that do not have the correct password are not able to access the network or share the stored content on the networked DVR.

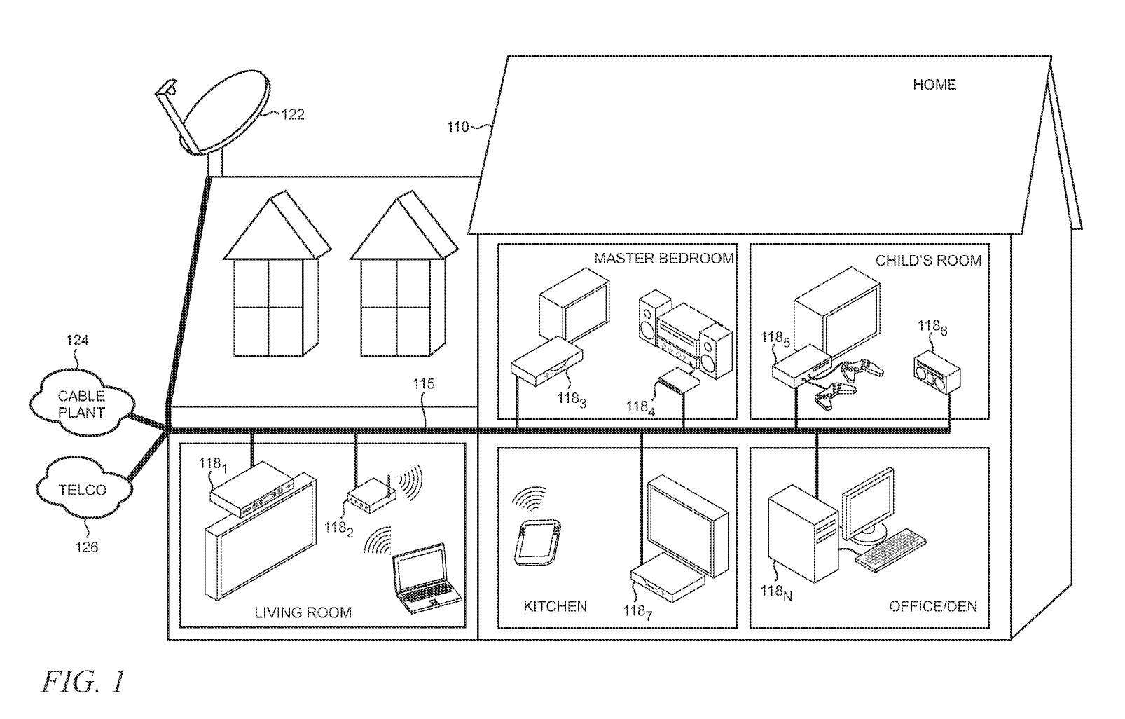

Turning now to FIG. 1, a pictorial representation of an illustrative arrangement is provided which shows a home 110 with infrastructure 115 to which a plurality of illustrative terminal devices 118₁ to 118_{N} are coupled. Connected to the terminal devices 118 are a variety of consumer electronic devices that are arranged to consume multimedia content. For example, terminal device 118₁ is a STB with an integrated networkable DVR which functions as a home network multimedia server, as described in detail below.

Several network sources are coupled to deliver broadband multimedia content to home 110 and are typically configured as wide area networks (“WANs”). A satellite network source, such as one used in conjunction with a direct broadcast satellite (“DBS”) service is indicated by reference numeral 122. A cable plant 124 and a telecommunications network 126, for example for implementing a digital subscriber line (“DSL”) service, are also coupled to home 110.

In the illustrative arrangement of FIG. 1, infrastructure 115 is implemented using coaxial cable that is run to the various rooms in the house, as shown. Such coaxial cable is commonly used as a distribution medium for the multimedia content provided by network sources 122, 124 and 126. In alternative examples, infrastructure 115 is implemented using telephone or power wiring in the home 110 or conventional network wiring such as Cat-5 (Category 5) Ethernet cabling. In accordance with the present arrangement for password installation, infrastructure 115 also supports a home local area network (“LAN”), and more particularly, a home multimedia network.

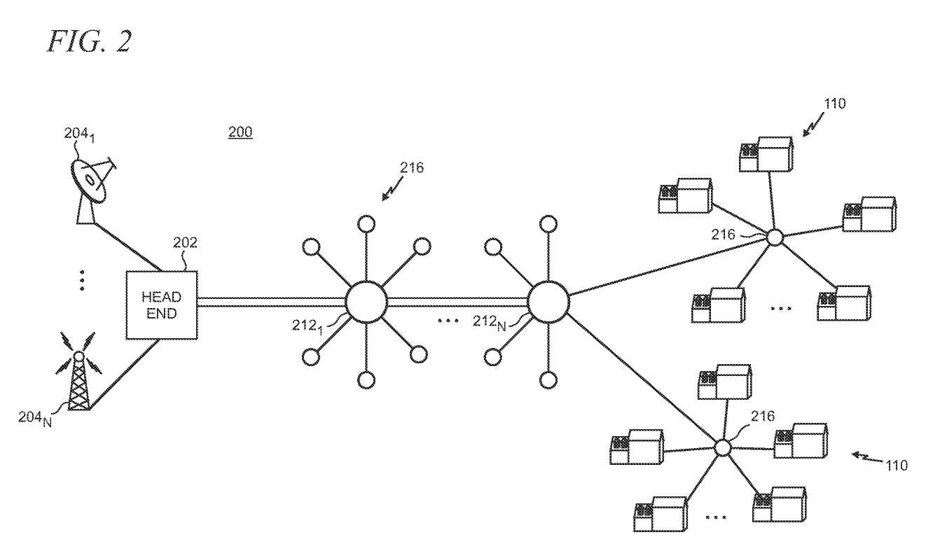

FIG. 2 is a block diagram of an illustrative multimedia delivery network 200 having a network headend 202, hubs 212₁ to 212_{N} coupled to the headend 202, and nodes (collectively indicated by reference numeral 216) coupled to the hubs 212. Nodes 216 each provide broadband multimedia services to a plurality of homes 110, as shown. Multimedia delivery network 200 is, in this example, a cable television/entertainment network. However, DBS and telecommunication networks are operated with substantially similar functionality.

Headend 202 is coupled to receive programming content from sources 204, typically a plurality of sources, including an antenna tower and satellite dish as in this example. In various alternative applications, programming content is also received using microwave or other feeds including direct fiber links to programming content sources.

Network 200 uses a hybrid fiber/coaxial (“HFC”) cable plant that comprises fiber running among the headend 202 and hubs 212 and coaxial cable arranged as feeders and drops from the nodes 216 to homes 110. Each node 216 typically supports several hundred homes 110 using common coaxial cable infrastructure in a tree and branch configuration. As a result, as noted above, the potential exists for content stored on a networked DVR in one home on a node to be unintendedly viewed by another home on the node unless steps are taken to isolate the portions of the cable plant in each home that are utilized to implement the home multimedia network.

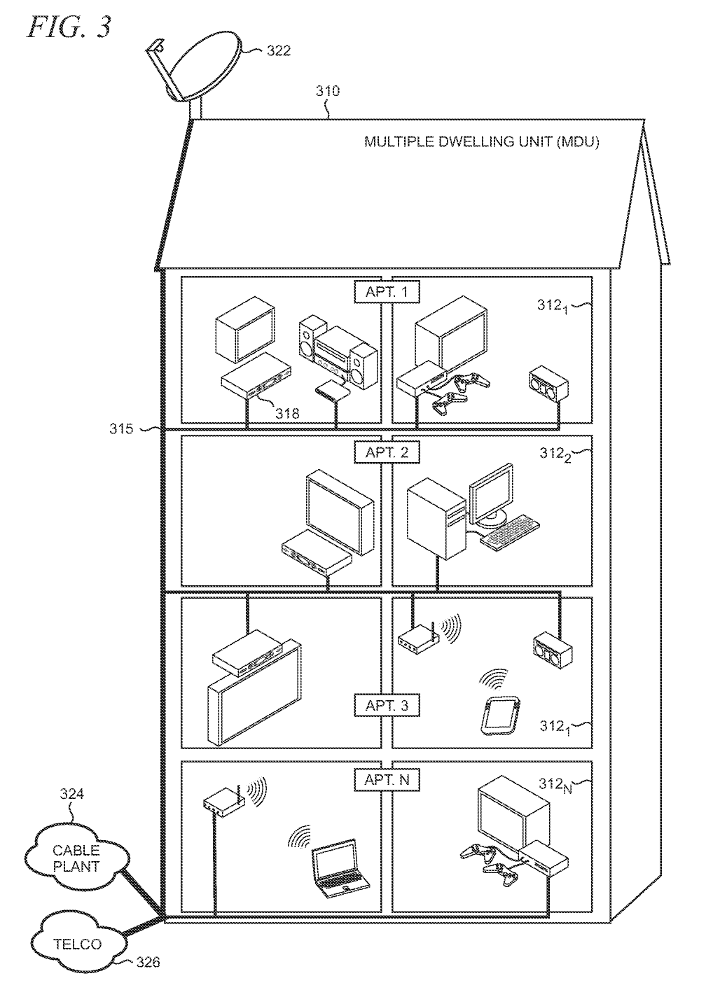

FIG. 3 is a pictorial representation of an illustrative multiple dwelling unit 310 having a number of apartments 312₁ to 312_{N}, each with a plurality of terminal devices coupled to a common coaxial cable infrastructure 315. In a similar manner to that shown in FIG. 1 and described in the accompanying text, MDU 310 receives broadband multimedia services from WANs including a satellite network source 322, cable plant 324 and telecommunications network 326.

Apartments 312 each use respective portions of infrastructure 315 to implement a LAN comprising a home multimedia network. Since apartments 312 share common infrastructure 315, measures must be taken to isolate each home multimedia network in the MDU so that content stored on a networkable DVR in STB 318, for example apartment 1, is not unintendedly viewed in apartment 2 in MDU 310.

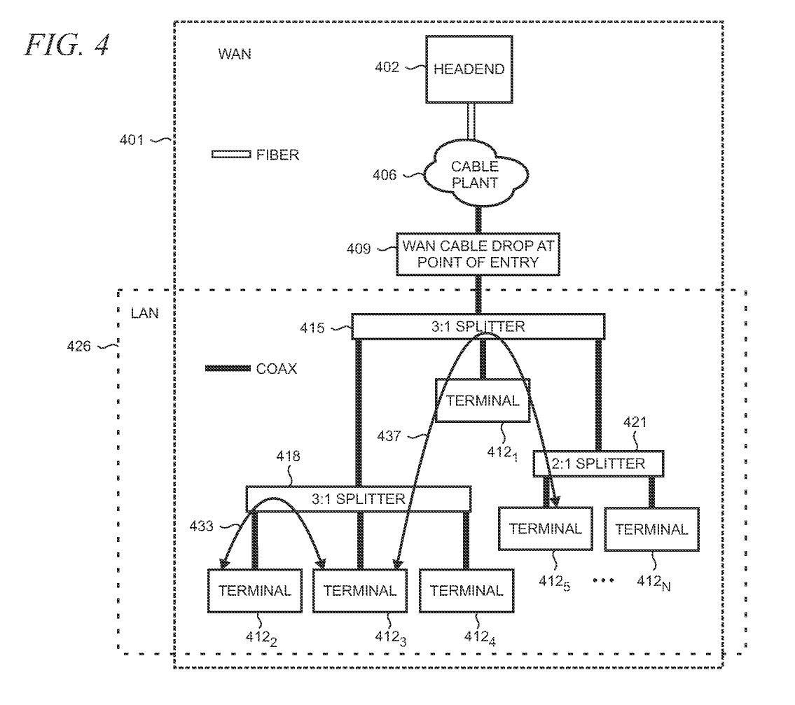

FIG. 4 shows an example of how the wide area and local area networks described above share a common portion of physical infrastructure. A WAN 401, for example a cable television network, includes a headend 402 and cable plant 406. Cable plant 406 is typically arranged as a HFC network having coaxial cable drops at a plurality of terminations at broadband multimedia service subscribers' buildings such as homes, offices, and MDUs. One such cable drop is indicated by reference number 409 in FIG. 4.

From the cable drop 409, WAN 401 is coupled to individual terminals 412₁ to 412_{N} using a plurality of splitters, including 3:1 splitters 415 and 418 and a 2:1 splitter 421 and coaxial cable (indicated by the heavy lines in FIG. 4). It is noted that the number and configuration of splitters shown in FIG. 4 is illustrative and other types and quantities of splitters will vary depending on the number of terminals deployed in a particular application. Headend 402 is thus coupled directly to each of the terminals 412 in the premises to enable multimedia content to be streamed to the terminals over the WAN 401. In most applications, terminals 412 and cable plant 406 are arranged with two-way communication capability so that signals which originate at a subscriber's premises can be delivered back upstream to the headend. Such capability enables the implementation of a variety of interactive services. It further provides a subscriber with a convenient way to order services from the headend, make queries as to account status, and browse available multimedia choices using an electronic programming guide (“EPG”), for example.

In typical applications WAN 401 operates with multiple channels using RF (radio frequency) signals in the range of around 50 to as high as 860 Mhz for downstream communications (i.e., from headend to terminal). Upstream communications (i.e., from terminal to headend) have a typical frequency range from around 5 to 42 MHz.

In this illustrative example, LAN 426 commonly shares the portion of networking infrastructure installed at the building with WAN 401. More specifically, as shown in FIG. 4, the coaxial cable and splitters in the building are used to enable inter-terminal communication. This is accomplished using a network or communications interface in each terminal, such as a network interface module (“NIM”), chipset or other circuits, that provides an ability for an RF signal to jump backwards through one or more splitters. Such splitter jumping is illustratively indicated by arrows 433 and 437 in FIG. 4.

In many applications, LAN 426 is arranged with the capability for operating multiple RF channels in the range of 800-1550 MHz, with a typical operating range of 1 to 1.5 GHz. LAN 426 is also generally arranged as an IP (Internet protocol) network. Other networks operating at other RF frequencies may optionally use portions of the LAN 426 and WAN 401 infrastructure. For example, a broadband internet access network using a cable modem (not shown), voice over internet protocol (“VOIP”) network, and/or out of band (“OOB”) control signaling and messaging network functionalities are commonly operated on LAN 426 in many applications.

The above-described network infrastructure is an example of one suitable home network type which particularly supports the emerging Multimedia Over Coax Alliance (“MoCA”) networking standard. However, other network infrastructure types are also intended as being usable with present two-step password installation arrangement including those which use home phone wiring or power wiring. For example, HomePlug network, HPNA (Home Phoneline Networking Alliance also called “HPNA”) networks, and other powerline network or telephone networks may be beneficially utilized in some applications. In addition, the present arrangement may also be adapted to conventional wired or wireless networks, or to any network where security is implemented using some type of commonly-shared password.

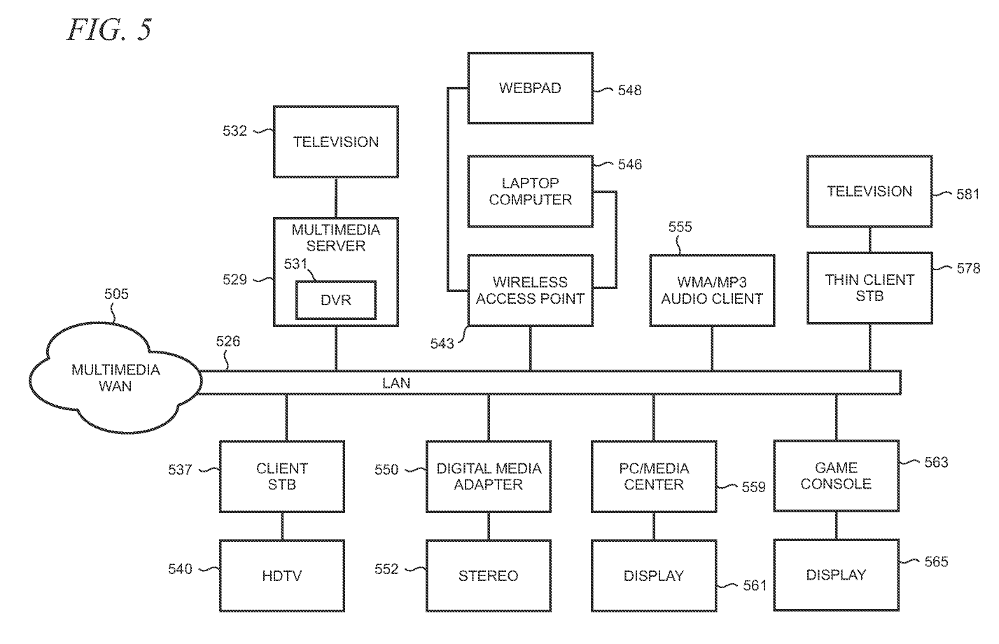

FIG. 5 is a functional block diagram of an illustrative LAN 526, having a plurality of coupled terminal devices, that is operated in a multimedia service subscriber's home. As with the arrangement shown in FIG. 4 and described in the accompanying text, the terminal devices coupled to LAN 526 are also coupled to a WAN 505 to receive multimedia content services such as television programming, movies and music from a service provider. Thus, WAN 505 and LAN 526 share a portion of common networking infrastructure, which in this example is coaxial cable, but operate at different frequencies.

A variety of terminal devices are coupled to LAN 526 in this illustrative example. It is emphasized that the number and type of terminal devices shown in FIG. 5 are merely illustrative and that other arrangements may by utilized as required by specific circumstances.

A multimedia server 529 is coupled to LAN 526. Multimedia server 529 is arranged using a STB with integrated networkable DVR 531. Alternatively, multimedia server is arranged from devices such as personal computers, media jukeboxes, audio/visual file servers, and other devices that can store and serve multimedia content over LAN 526. Multimedia server 529 is further coupled to a television 532.

Client STB 537 is another example of a terminal device that is coupled to LAN 526 and WAN 505. Client STB 537 is arranged to receive multimedia content over WAN 505 which is playable on the coupled HDTV 540 (high definition television). Client STB 537 is also arranged to communicate with other terminals on LAN 526, including for example multimedia server 529, in order to access content stored on the DVR 531. Thus, for example, a high definition PPV movie that is recorded on DVR 531 in multimedia server 529 located in the living room of the home can be watched on the HDTV 540 in the home's family room.

Wireless access point 543 allows network services and content from WAN 505 and LAN 526 to be accessed and shared with wireless devices such as laptop computer 546 and webpad 548. Such devices with wireless communications capabilities (implemented, for example, using the Institute of Electrical and Electronics Engineers IEEE 802.11 wireless communications protocols) are commonly used in many home networking applications. Thus, for example, photographs stored on DVR 531 can be accessed on the webpad 548 that is located in the kitchen of the home over LAN 526.

A digital media adapter 550 allows network services and content from WAN 505 and LAN 526 to be accessed and shared with media players such as home entertainment centers or stereo 552. Digital media adapter 550 is typically configured to take content stored and transmitted in a digital format and convert it into an analog signal. For example, a streaming internet radio broadcast received from WAN 505 and recorded on DVR 531 is accessible for play on stereo 552 in the home's master bedroom.

WMA/MP3 audio client 555 is an example of a class of devices that can access digital data directly without the use of external digital to analog conversion. WMA/MP3 client 555 is a music player that supports the common Windows Media Audio digital file format and/or the Moving Picture Expert Group (“MPEG”) Audio Layer 3 digital file format, for example. WMA/MP3 audio client 555 might be located in a child's room in the home to listen to a music channel supplied over WAN 505 or access an MP3 music library that is stored on DVR 531 using LAN 526.

A personal computer, PC 559 (which is optionally arranged as a media center-type PC typically having one or more DVD drives, a large capacity hard disk drive, and high resolution graphics adapter) is coupled to WAN 505 and LAN 526 to access and play streamed or stored media content on coupled display device 561 such as a flat panel monitor. PC 559, which for example is located in an office/den in the home, may thus access recorded content on DVR 531, such as a television show, and watch it on the display device 561. In alternative arrangements, PC 559 is used as a multimedia server having similar content sharing functionalities and features as multimedia server 529 that is described above.

A game console 563 and coupled television 565, as might be found in a child's room, is also coupled to WAN 505 and LAN 526 to receive streaming and stored media content, respectively. Many current games consoles play game content as well as media content such as video and music. Online internet access is also used in many settings to enable multi-player network game sessions.

Thin client STB 578 couples a television 581 to WAN 505 and LAN 526. Thin client STB is an example of a class of STBs that feature basic functionality, usually enough to handle common EPG and VOD/PPV functions. Such devices tend to have lower powered central processing units and less random access memory than thick client STBs such as multimedia server 529 above. Thin client STB 578 is, however, configured with sufficient resources to host a user interface that enables a user to browse, select and play content stored on DVR 531 in multimedia server 529. Such user interface is configured, in this illustrative example, using an EPG-type interface that allows remotely stored content to be accessed and controlled just as if the content was originally received by thin client STB 578 and recorded on its own integrated DVR. That is, the common DVR programming controls including picking a program from the recorded library, playing it, using fast forward or fast back, and pause are supported by the user interface hosted on thin client STB 578 in a transparent manner for the user. The EPG interface may also be used to implement the two-step password installation as described below.

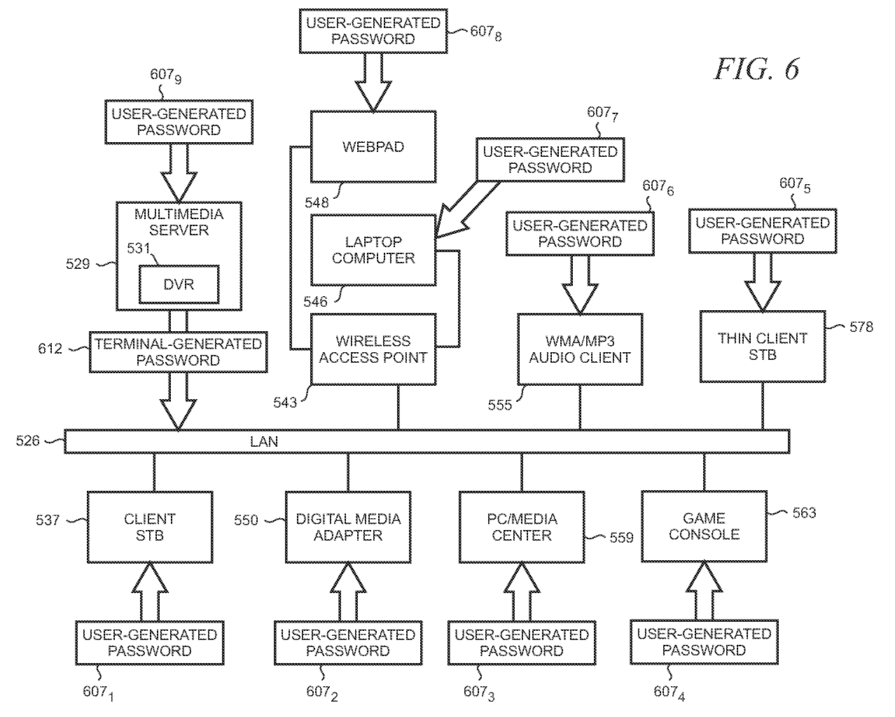

FIG. 6 is a functional block diagram showing the present two-step password installation including the user-generated password installation into the terminal devices shown in FIG. 5 and creation and distribution of a terminal-generated password over the LAN 526. As noted above, a password that is selected by a user is commonly installed on each terminal device in the network. In this illustrative example, a user is typically either a consumer such as a subscriber to a cable television/entertainment service, or a professional technician (i.e., installer) working for a provider of such a service.

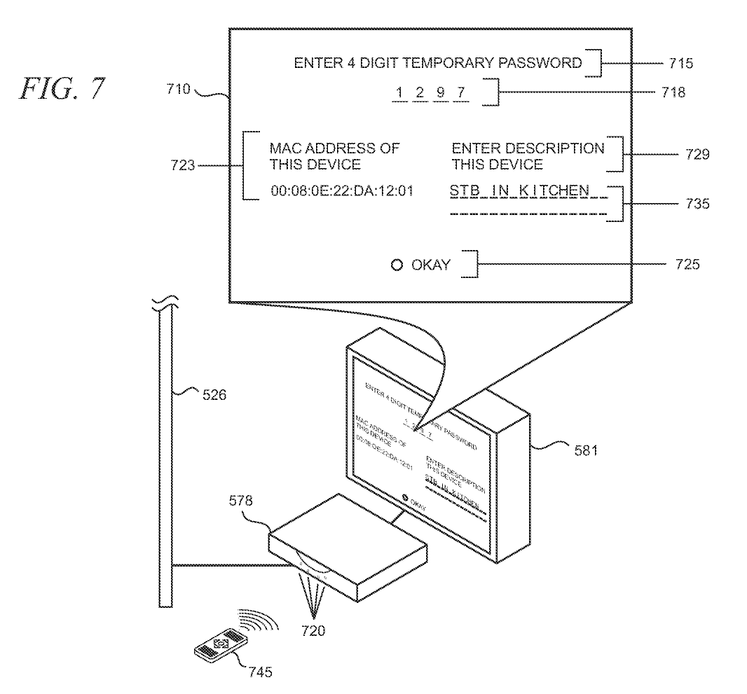

By interacting with a user interface as shown below in FIG. 7 and described in the accompany text, the user inputs a password that is typically a short sequence of a few easily remembered digits that is installed in the terminal device as a temporary password. In one example, in cases where the user is a professional installer, the password is the installer's identification or employee number.

As indicated by reference numerals 607₁₋₉ in FIG. 6, the user moves from terminal device to terminal device and commonly installs the same user-generated password in each of the terminal devices as the first step in the two-step process. Once all the terminal devices commonly share the user-generated password, they are able to form a temporarily-secured network. That is, communications are limited on the LAN 526 to only those terminal devices that possess the commonly-shared password.

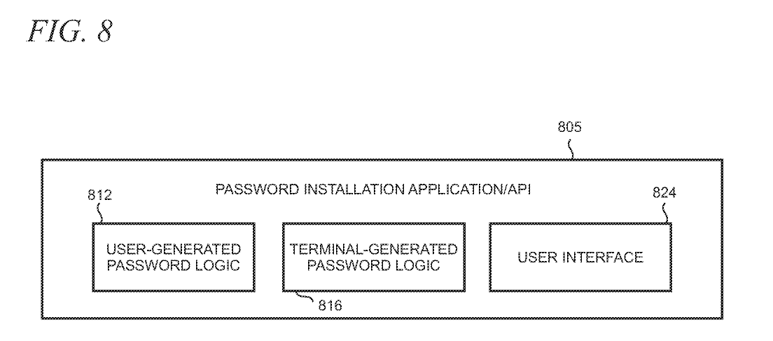

After the user-generated password is installed in each terminal device and the temporarily-secured network is formed on LAN 526, the user remains at the last terminal device in the home (which in FIG. 6 is multimedia server 529) to complete the second step of the password installation process. The user interacts with a user interface, as shown below in FIG. 8 and described in the accompanying text, to confirm that all the terminal devices are appropriately part of the network that is temporarily secured with the user-generated password. If so confirmed, the user initiates the creation of a terminal-generated password 612 that is distributed over LAN 526 to each of the terminal devices in which the user-generated password was previously installed. If the user determines that a terminal device was missed, or that a terminal device is unexpectedly part of the temporary network, then appropriate actions can be taken before the initiation of the creation of the terminal-generated password and distribution to the temporarily-secured terminal devices.

FIG. 7 is a pictorial view of an illustrative graphical user interface (“GUI”) screen 710 that is arranged to enable user input of a user-generated password and a text description for a terminal device. Screen 710 is displayed, in this example, on the television 581 that is coupled to the thin client STB 578 which, in turn, is coupled to LAN 526. Screen 710 is typically generated by a password installation application that is resident on the thin client STB 578. While thin client STB 578 is illustratively shown in FIG. 7, it is noted that each of the terminal devices shown in FIGS. 5 and 6 is generally arranged to host such an application. In addition, it is contemplated that other terminal devices are typically arranged to host the password installation application/API so that they may be added to a home network that is already secured using the present two-step password installation.

In alternative arrangements, the functionality provided by the password installation application is incorporated into existing applications that commonly run on terminal devices. For example, the software routines and methods provided by a standalone password installation application may be desired to be made part of an EPG. Or, an application programming interface (“API”) is usable for implementing password installation routines and methods that are accessed by other applications running on a terminal device.

The components forming an illustrative password installation application or application programming interface are shown in FIG. 8. The password installation application/API 805 includes a user-generated password logic module 812, a terminal-generated password logic module 816, and a user interface module 824. The user-generated password logic module 812 includes code which, when executed on a processor such as one disposed in one of the terminal devices shown in FIG. 5, implements the functionalities required to receive and use a user-generated password to access a network that is, or about to be temporarily secured using the user-generated password. Similarly, the terminal-generated password logic module 816 implements the functionalities required to generate and share a terminal-generated password so that the user-generated password is replaced and the network is secured using the terminal-generated password. The functionality required to display prompts and receive user inputs, typically as a GUI, is provided by the user-interface module 824.

Returning again to FIG. 7, screen 710 includes a prompt 715 for the user to input a temporary password as the first step in the two-step password installation. In this example, a four-digit password is provided, however other length passwords are usable depending on the requirements of a particular application. However, ordinarily a relatively short password is preferable and passwords of around two to four digits can be expected to perform satisfactorily since passwords of this length are generally easily remembered. As noted above, in cases where a professional installer is inputting the password, the installer's ID or employee number may be conveniently input as the password.

The user follows the prompts on screen 710 and inputs a desired password by using the buttons 720 on the front panel of thin client STB 578 or by using the remote control 745. In this example, the user has input a string including “1297” for the user-generated password as indicated by reference numeral 718 in FIG. 7.

Screen 710 also displays the MAC address 723 for a particular terminal device which, in this case, is thin client STB 578. A MAC address is an identifier that is associated with most forms of networking equipment. MAC addresses are globally unique in that no two devices share the same MAC address. The IEEE currently manages several MAC numbering spaces: MAC-48, EUI-48 (Extended Unique Identifier) and EUI-64. With MAC-48 and EUI-48, the address is usually displayed in hexadecimal form with each octet separated by a dash or a colon, as shown in FIG. 7. The first three octets are used to identify the manufacturer of the networking equipment. The last three octets represent the serial number assigned to the networking equipment by the manufacturer.

Screen 710 also includes a prompt 729 for the user to optionally input a text description that describes the terminal device and that will be associated with the displayed MAC address 723. Again, by interacting with the buttons 720 or remote control 745, the user inputs a desired text string. As indicated by reference numeral 735, the user has identified the thin client STB 578 as “STB in kitchen.” The user is provided with a control 725 on screen 710 to accept the password and text description once they have been input to the user's satisfaction.

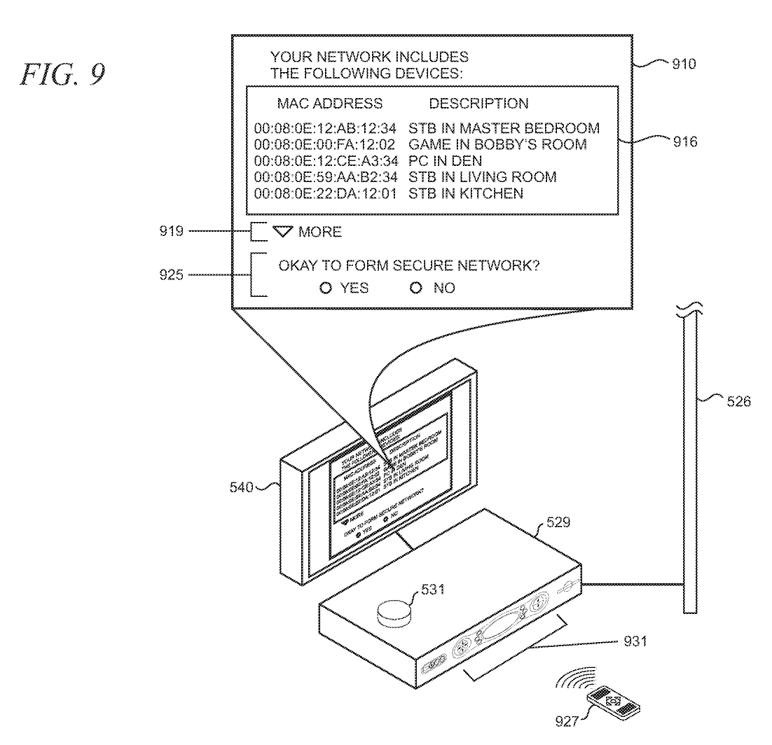

FIG. 9 is a pictorial view of an illustrative GUI screen 910 that is arranged to enable a user to verify a network configuration and complete a transition to a terminal-generated password by creating and distributing the terminal-generated password as the second step in the two-step password installation. Accordingly, as noted above, screen 910 is usually displayed on the last terminal device in which the temporary password is installed in a particular home network installation. In this example, screen 910 is displayed on the television 540 that is coupled to the multimedia server 529 which, in turn is coupled to LAN 526. It is emphasized that which terminal device is selected first and which is last is arbitrary and the particular sequence of terminal devices may be selected according to user preference. Generally, the location of the terminal devices and their proximity to each other are considered. Thus, a user might start with one conveniently located terminal device and then move from room to room and then from floor to floor in a house or MDU until all of the terminal devices have been visited and the user-generated password installed.

As with screen 710 (FIG. 7), screen 910 is typically generated through the password installation application or API that is resident on the multimedia server 529. Thus, in most applications of the present password installation, the password installation application or API includes functionalities to support the input of the user-generated password as well as the creation of the terminal-generated password.

Screen 910 includes a listing 916 of all the terminal devices that have been admitted to the network on LAN 526 that is temporarily secured with the user-generated password that was created using the interface shown in FIG. 7. Listing 916 includes the MAC address for each of the terminal devices admitted to the temporarily-secured network along with its associated optional text description input by the user when the temporary password was installed onto that terminal device. Screen 910 may include multiple pages of information, depending on the size of the temporarily-secured network and the amount of information to be displayed, that are accessed by common GUI techniques such as scrolling or button pushes (e.g., button 919) that a user manipulates using remote control 927 or controls 931 on STB 529.

The user will usually wish to review listing 916 for omissions or errors. For example, a terminal device may be missing from the listing 916 which likely means that it was inadvertently skipped over during the user-generated password installation step, or otherwise may have some technical issue that is preventing it from accessing the temporarily secured network. Or, a terminal device may be included in listing 916 that is unexpected. For example, one or more terminal devices in a nearby house or apartment sharing a portion of the same cable plant may be coincidentally using an identical user-generated password. Aside from a technical malfunction in the neighboring terminal device, this situation could occur if the device is in the process of transitioning to a terminal-generated password. It could also occur if the user of the neighboring terminal device decided for some reason to utilize the user-generated password on a longer term basis and not transition to the terminal-generated password. However, in many applications of the present password installation paradigm, the user-generated password is intended for temporary use only, for example, by being set to expire after the end of a time interval by the password installation application/API. The time interval is normally set to allow sufficient time for the user to install the user-generated password in each terminal device while still being short enough to minimize the security risk associated with the use of a typically short and simple password.

After confirming that the terminal devices contained in listing 916 are appropriately part of the temporarily-secured network, the user makes a selection from a menu 925 to initiate formation of a network on LAN 526 that is secured by the terminal-generated password 612 (FIG. 6). In this illustrative example, the terminal-generated password 612 is created by the password application or API running on the multimedia server 529. The terminal-generated password is typically configured as a numeric or alpha-numeric password having a sufficient number of digits to provide robust protection against password attacks. For example, in the case of MoCA network applications, passwords are typically selected with a count of between 12 and 17 numeric digits.

The terminal-generated password 612 is created using one of several alternative techniques. In some applications, a look-up table containing a number of available passwords is utilized. Alternatively, the terminal-generated password 612 may be created using a random number generation function. Another illustrative method utilizes one or more MAC addresses from the terminal devices forming the temporarily secured network on LAN 526. Here, the globally unique MAC address or combination of several such MAC addresses are used as input into either a random number generation or hash function (e.g., CRC32, SHA-1, MD5 etc.) which then outputs the terminal-generated password 612. This method provides a high probability that the terminal-generated password used to secure the network will be unique to that network.

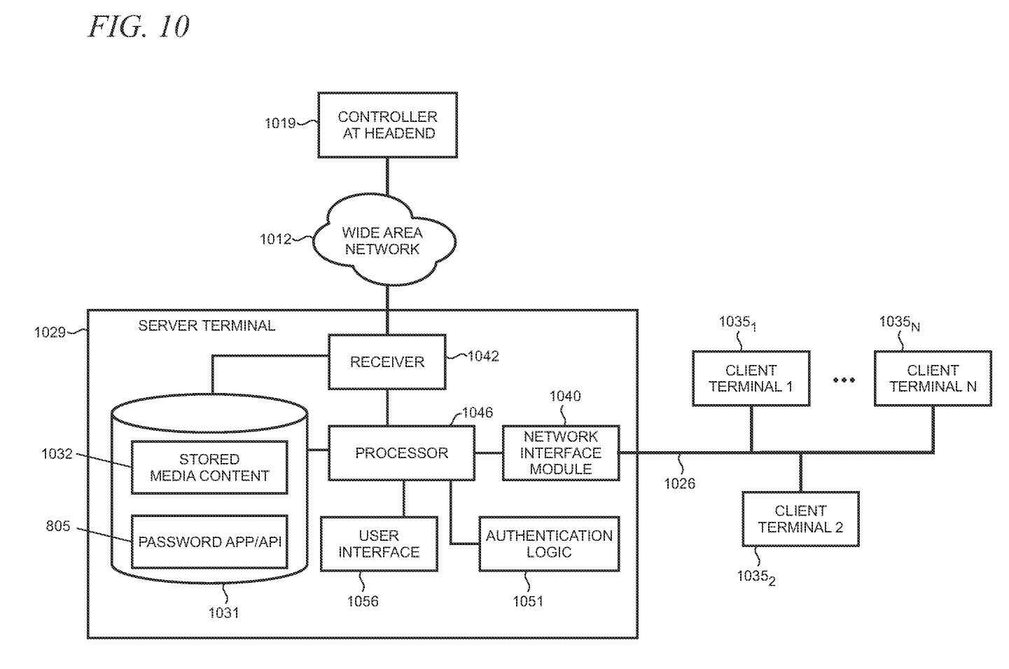

FIG. 10 is a functional block diagram of an illustrative server terminal 1029 that is coupled to a WAN 1012 and a LAN 1026. A controller 1019 at a headend provides programming content over WAN 1012. The controller 1019 modulates programming content from sources 204 (FIG. 2) on to the WAN 1012 along with control information, messages, and other data, using the OOB network. WAN 1012 and LAN 1026 are arrangable in a similar manner as their counterparts shown in FIG. 4 and described in the accompanying text.

Server terminal 1029 includes a receiver 1042 arranged to receive media content from the headend controller 1019. Receiver 1042 is coupled to a processor 1046 in server terminal 1029 which records selected media content to memory 1031 using the DVR.

Server terminal 1029, in this illustrative example, is arranged as a multimedia server in a similar fashion as multimedia server 529 in FIG. 5, and thus includes a memory 1031. Memory 1031 is alternatively arranged as a hard disk drive or RAM (random access memory). Memory 1031 is shareable with the networkable DVR function that is typically included within server terminal 1029 in most applications. As shown in FIG. 10, memory 1031 is arranged to store shareable media content 1032, such as a PPV or VOD movie that is received from the headend controller 1019. Memory 1031 also stores the password installation application/API 805 as shown in FIG. 8 and described in the accompanying text.

Authentication logic 1051 is coupled to the processor 1046, as shown, that is utilized to perform authentication attendant to the formation of a secure content sharing network, as described below, first by using the user-generated password and then using the terminal-generated password. In some applications, the authentication logic is disposed or incorporated within a NIM that is commonly utilized to implement inter-terminal communications.

A number of client terminals 1035₁ to 1035_{N}, are coupled to server terminal 1029 on LAN 1026. In this illustrative example, client terminals 1035 include a variety of the terminal devices as shown in FIG. 5 and described in the accompanying text. Server terminal 1029 employs a NIM 1040 to enable communications using LAN 1026 as an IP network with the client terminals 1035. Client terminals 1035 are also each typically equipped with a NIM device. It is noted that the designations of server and clients in FIG. 10 is merely illustrative as shareable media content may be stored in, and served from more than one terminal device on the LAN 1026. Accordingly, it can be expected that the client terminal 1035 will include similar features and elements as shown in server terminal 1029. However, not all client terminals would normally be equipped with networkable DVR functionality in most applications.

A user interface 1056 enables user interaction with server terminal 1029 typically by accepting user input through physical controls (e.g., buttons on the front panel of server terminal 1029) or remote control (e.g., remote control 745 in FIG. 7) and displaying prompts on a coupled monitor or television. As noted above, the user may utilize the front panel buttons or remote control to input the user-generated password and initiate the creation and distribution of the terminal-generated password.

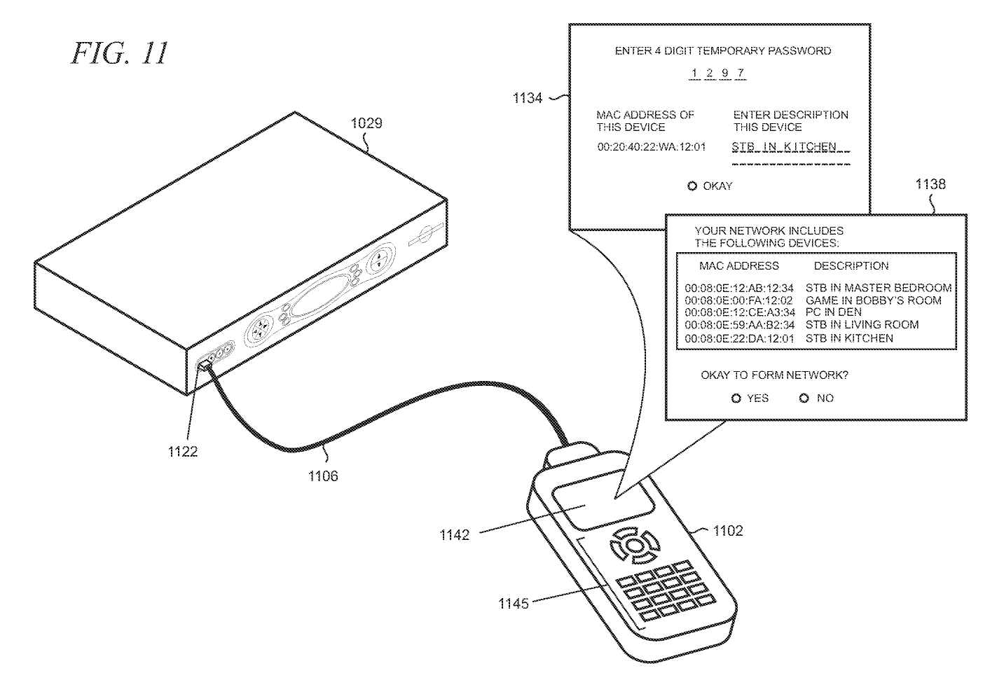

FIG. 11 shows an illustrative installation tool 1102 that hosts a password installation application/API. The password installation application/API is arranged in a similar manner as the application/API 805 (FIG. 8). Installation tool 1102 is optionally and alternatively usable to enable terminal devices to use the present two-step password installation. For example, installation tool 1102 is utilized in settings where some or all of the terminal devices in a home are not arranged to host a password installation application or API. Installation tool is also usable in cases when a terminal device is not configured with its own user interface.

Installation tool 1102, in this illustrative example, is coupled with a cable 1106 to the server terminal 1029 via a USB (Universal Serial Bus) port 1122. In alternative implementations, installation tool 1102 communicates with the terminal device using a wireless connection such as one provided by IEEE 802.11, Bluetooth or ZigBee. The communication connection enables a user of the installation tool 1102 to select and install a user-generated password that is used by the authentication logic 1051 (FIG. 10) in the server terminal 1029 to access and secure the network using the user-generated password. The user also initiates the creation and distribution of the terminal-generated password using the installation tool 1102.

Installation tool 1102 displays GUI screens 1134 and 1138 on its display 1142. Screens 1134 and 1138 are arranged in a similar manner as screens 710 and 910 in FIGS. 7 and 9, respectively. Display 1142 is integrated in installation tool 1102 in this illustrative example. In alternative arrangements, an external display (not shown) is also usable. The user navigates and makes selections and entries responsively to screens 1134 and 1138 by using controls 1145. Alternatively, display 1142 is arrangable as a touch screen display that may be used to supplement or replace user input with controls 1145.

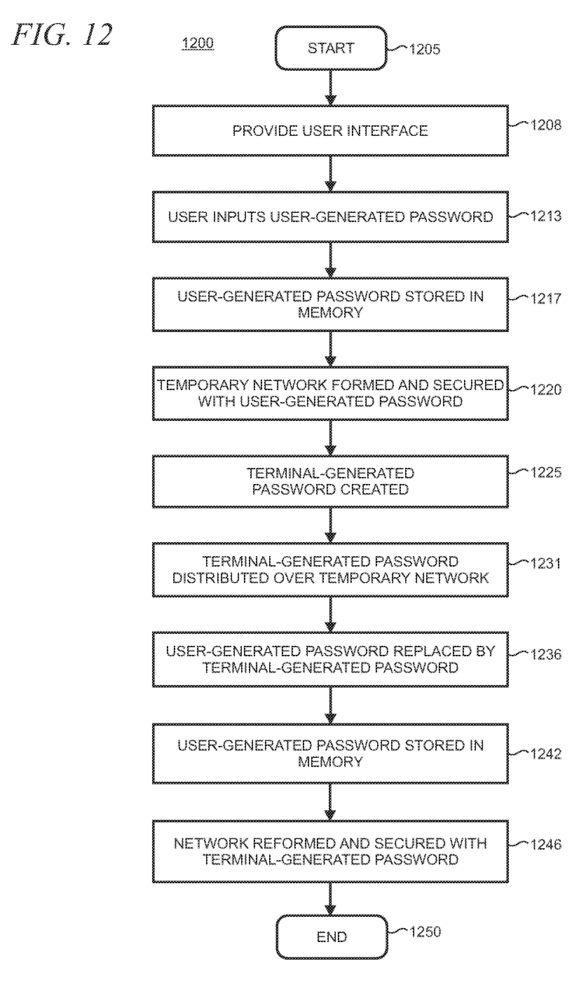

FIG. 12 is a flowchart of an illustrative method 1200 for implementing two-step password installation among a plurality of terminals so that the terminals are able to securely share content over a LAN. Method 1200 may be performed, in one illustrative example, using the home network arrangement shown in FIGS. 5 and 6 and described in the accompanying text. The method starts at block 1205.

At block 1208, a password installation user interface is provided by each of the terminal devices on the LAN 526. The password installation user interface is provided to a user, such as a consumer or professional installer, by the password installation application/API 805 (FIG. 8) that is hosted by each terminal device. Installation tool 1102 (FIG. 11) is also usable alone, or in combination with password installation application/API 805 so that the user may interact with each terminal device.

The user interacts with the user interface to input a user-generated password as shown at block 1213. As noted above, in typical applications the user-generated password is a short and easily remembered password. Such interaction may be facilitated using the GUI screens 710 and 1134 in FIGS. 7 and 11, respectively. The same user-generated password is input into each terminal device on LAN 526. At block 1217, the commonly-shared user-generated password is installed and stored in each terminal device, typically in a non-volatile memory.

An alternative to the input of a user-generated password at block 1213, is the utilization of a network name that is commonly stored in each of the plurality of terminal devices. The network name is essentially an analog to the service set identifier (“SSID”) that is used in wireless networks and functions as a password between devices and wireless access points. Here, the commonly stored network name (which may be any arbitrarily selected combination of numbers and/or characters) is selected as the temporary password when the user pushes a button on each terminal device disposed on the LAN 526. The push button is typically either enabled as a physical hardware button on the device, or implemented as a virtual button using a GUI. This “push button” password utilization paradigm enables the terminals to form a secure network with the commonly-shared network name in lieu of an input password. However, the potential use of the network name as a temporary password is typically time-limited. For example, after a period of time such as two or three minutes, if push button-activated terminal devices have not associated with each other to form a network, the network name password is disabled. This could occur, for example, if the user gets delayed when moving from one device to another in activating the push button. In this case, the user would be required to retry the push button on each of terminal device that is desired to be networked.

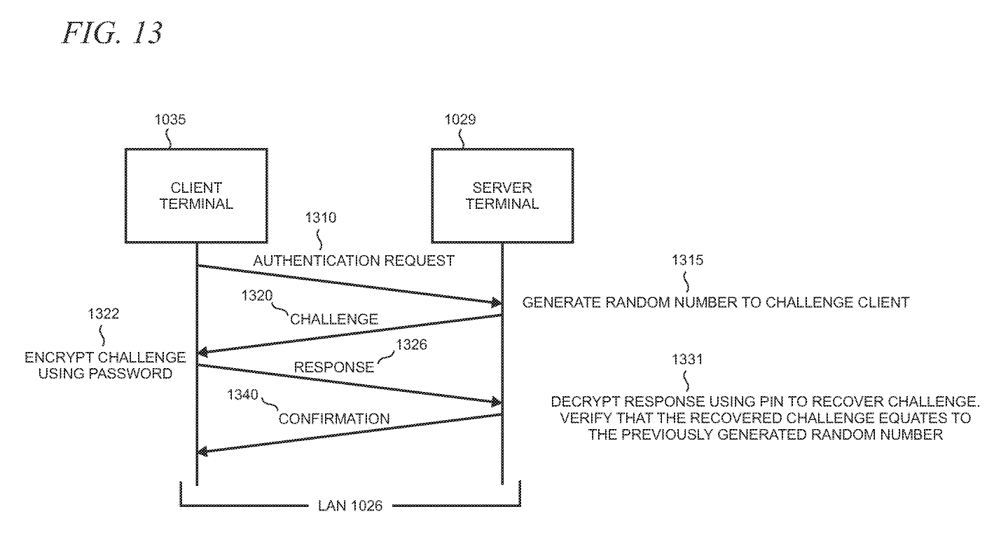

Once each terminal device on LAN 526 has the commonly-shared user-generated password installed, a network is formed that is temporarily-secured using the user-generated password as indicated by block 1220. Accordingly, only terminal devices which have the commonly-shared user-generated password are able to share data over the temporary network. Shared-key authentication is one illustrative methodology that is usable to form and secure the network as described below in the text accompanying FIG. 13.

At block 1225 in FIG. 12, at one of the terminal devices selected by the user, a terminal-generated password is created. As noted above, a variety of techniques are alternatively usable to facilitate creation of the terminal-generated password. In this illustrative example, the terminal-generated password is produced by a CRC-32 hash function which takes a combination of MAC addresses as an input from several terminal devices on the temporarily secured network operating on LAN 526. The output from the hash function is truncated to 17 digits to form the terminal-generated password.

At block 1231, the terminal-generated password is distributed to each of the terminal devices on the temporarily-secured network operating over LAN 526. The terminal-generated password is used by the password installation application/API 805 to replace the commonly-shared user-generated password at each of the terminal devices, as shown in block 1236. The terminal-generated password is installed and stored in each of the terminal devices, typically in a non-volatile memory as shown in block 1242.

Once each terminal device on LAN 526 has the commonly-shared terminal-generated password installed, as indicated by block 1246, the network is reformed and secured using the terminal-generated password. Shared-key authentication is again used in this illustrative example to form and secure the network operating on LAN 526 using the terminal-generated password. The illustrative method 1200 ends at block 1250.

FIG. 13 is a diagram showing an illustrative shared-key authentication message flow between the server terminal 1029 and one of the client terminals 1035 over LAN 1026 which are shown in FIG. 10. In this illustrative example, the authentication message flow is utilized at each step of the present two-step password installation—once when the network is formed and temporarily-secured with the user-generated password, and then again when the network is reformed and then secured using the terminal-generated password.

In this illustrative example, the messages are conveyed as MAC sublayer messages which are transported in the data link layer of the OSI (Open Systems Interconnection) model on the IP network which operates on LAN 1026. In most applications of two-step password installation, the authentication attendant to the network formation is performed by the authentication logic 1051 which may be incorporated into the NIM 1040. Alternatively, the authentication is performed by the implementation of instructions that are part of the password installation application/API 805.

Client terminal 1035 sends an authentication request message 1310 to server terminal 1029. Client terminal 1035 sends the authentication request message 1310 when it is looking to join a network operating on LAN 1026 to thereby consume stored content (such as programming recorded on the DVR disposed in the server terminal 1029) or otherwise. In response to the authentication request, server terminal 1029 generates a random number as indicated by reference numeral 1315. The random number is used to create a challenge message 1320 which is sent back to client terminal 1035.

As indicated by reference numeral 1322 in FIG. 13, client terminal 1035 encrypts the challenge using the commonly-shared password (that is received as shown in the illustrative flowchart of FIG. 8 and described in the accompanying text). Client terminal 1035 uses any of a variety of known encryption techniques, such as the RC4 stream cipher, to encrypt the challenge (as indicated by reference numeral 1322) using the password to initialize a pseudorandom keystream. Client terminal 1035 sends the encrypted challenge as a response message 1026 to the server terminal 1029.

As indicated by reference numeral 1331 in FIG. 13, the server terminal 1029 decrypts the response message 1326 using the commonly-shared password to recover the challenge. The recovered challenge from the client terminal 1035 is compared against the original random number. If a successful match is identified, a confirmation message 1340 is sent from the server terminal 1029 to the client terminal 1035.

Each of the processes shown in the figures and described in the accompanying text may be implemented in a general, multi-purpose or single purpose processor. Such a processor will execute instructions, either at the assembly, compiled, or machine-level, to perform that process. Those instructions can be written by one of ordinary skill in the art following the description herein and stored or transmitted on a computer readable medium. The instructions may also be created using source code or any other known computer-aided design tool. A computer readable medium may be any medium capable of carrying those instructions and include a CD-ROM (compact disc read-only-memory), DVD (digital versatile disc), magnetic or other optical disc, tape, silicon memory (e.g., removable, non-removable, volatile or non-volatile), packetized or non-packetized wireline or wireless transmission signals.

What is claimed is:

1. A terminal arranged to securely share data, comprising:
a network interface for receiving multimedia content and connecting to at least one other terminal over a network;
one or more processors; and
a memory storing instructions which, when executed by the one or more processors, implement
a) first password logic for receiving a first password that is used by the terminal to securely form the network with the at least one other terminal, and
b) second password logic for receiving a second password from the at least one other terminal over the network secured by the first password and for resetting the first password with the second password to thereby secure the network using the second password.

2. The terminal of claim 1 in which the memory is further arranged to store multimedia content, the multimedia content being received from the at least one other terminal or from a multimedia content source.

3. The terminal of claim 1 in which the network interface, one or more processors, and memory are substantially incorporated in one of set top box, personal computer, DVR, PVR, whole home DVR, multi-room DVR, or networkable client device.

4. The terminal of claim 1 in which the network is one of MoCA network, HomePlug network, HPNA network, powerline network, or telephone network.

5. The terminal of claim 1 in which the network secured by the second password is usable to share multimedia content stored on the terminal with the at least one other terminal.

6. The terminal of claim 1 in which the multimedia content is selected from one of video, music, pictures, or data.

7. The terminal of claim 1 in which the first password is generated using a push button password utilization paradigm.

8. A computer-readable medium containing instructions which, when executed by one or more processor disposed in an electronic device, performs a method comprising:
providing a user interface to enable user input of a temporary password that is usable by a first terminal for authenticating other terminals which possess the temporary password so as to form a temporary network on an infrastructure that is commonly shared by the first terminal and the other terminals;
generating a new password; and
transmitting the new password over the temporary network to authenticated terminals to replace the temporary password and form a password-secured network using the new password on the commonly shared infrastructure.

9. The computer-readable medium of claim 8 in which the access request initiates a challenge-response using the temporary password.

10. The computer-readable medium of claim 9 in which the challenge-response includes generation of a random number as a challenge which is encrypted as a response by a terminal receiving the request.

11. The computer-readable medium of claim 8 in which a portion of the infrastructure supports a multimedia content distribution network that is shared as the password-secured network and each network operates at a different frequency on the shared portion of infrastructure.

12. The computer-readable medium of claim 8 in which the password-secured network operates as a local area network to share content among authenticated terminals.

13. The computer-readable medium of claim 8 in which the user interface is arranged to enable a user to input a text description that is associated with one or more authenticated terminals.

14. The computer-readable medium of claim 13 in which the text description is associated with a MAC address of an authenticated terminal.

15. A method for enabling data to be securely shared over an infrastructure, the method comprising:
storing a user-generated password in a memory of a terminal;
using the user-generated password for shared-key authentication for forming a network on the infrastructure with authenticated terminals;
generating a terminal-generated password; and
transmitting the terminal-generated password to the authenticated terminals on the network to thereby securely share data using the second password.

16. The method of claim 15 in which the terminal-generated password is generated using information that is uniquely associated with at least one of the authenticated terminals.

17. The method of claim 16 in which the information comprises a MAC address of the at least one of the authenticated terminals.

18. The method of claim 16 in which the information comprises one or more MAC addresses associated with respective authenticated terminals.

19. The method of claim 15 in which the user-generated password is a temporary password and the terminal-generated password is a permanent password.

20. The method of claim 15 in which the user-generated password is shorter in length than the terminal-generated password.

21. The method of claim 15 in which the user-generated password comprises a string that is input by a user to a user interface, the user interface being selected from a user interface that is couplable to the terminal or a user interface that is hosted by the terminal.
